(19) United States
(12) Patent Application Publication
(10) Pub. No.: US 2004/0225239 A1
(43) Pub. Date: Nov. 11, 2004

(54) Massage machine and massage method

(76) Inventors: Yasushi Yamamoto, Osaka (JP); Masahiko Hashimoto, Osaka (JP); Kazuya Hiyamizu, Osaka (JP); Makoto Kikumoto, Osaka (JP); Hirokazu Genno, Osaka (JP)

Correspondence Address: MCDERMOTT, WILL & EMERY, 600 13th Street, N.W., Washington, DC, 20005-3096, US

(21) Appl. No.: 10/772,582

(22) Filed: Feb. 6, 2004

(30) Foreign Application Priority Data
Feb. 6, 2003 (JP) 2003-029573
Feb. 28, 2003 (JP) 2003-054855

(51) Int. Cl. A61H 15/00

(52) U.S. Cl. 601/84; 601/98; 601/101; 601/103; 601/116

(57) ABSTRACT

The present invention provides a massage machine comprising a physiological sensor 5 for detecting physiological data of autonomic nerve system of the user and a control circuit 6 for controlling a massage operation based on the physiological data detected by the sensor 5. The control circuit 6 estimates a psychological state of the user based on variations of the physiological data detected by the sensor 5 by an execution of a preliminary massage, and thereafter adjusts a full massage operation in accordance with the estimated psychological state. For the preliminary massage, one typical massage movement is performed from among a plurality of massage movements to be performed for the full massage.

### FIELD OF THE INVENTION

The present invention relates to massage machines adapted to give one or some kinds of massages to the user, and more specifically to massage machines and massage method for giving Shiatsu or finger pressure therapy to parts such as the shoulder, back, and waist of the user seating on a chair-type massage machine.

### BACKGROUND OF THE INVENTION

With reference to FIG. 1, massage machines generally comprise a chair body 10 including legs 11, a seat 12, a backrest 13, and a pair of opposite armrests 14, 14 and a massage mechanism 2 having a plurality of massage balls 21 and incorporated into the chair body 10. The massage balls 21 are reciprocatingly moved up and down while being vibrated, whereby the human body is massaged.

The massage machines of the type mentioned include one which is adapted to detect a stiff body part before and after giving a massage so as to massage the most appropriate part concentrically [JP-A No. 9-75413(1997)]. However, the massage machine is unable to detect the psychological state of the user such as “comfort” or “pain,” and therefore has the problem of failing to give an effective massage for realizing an enhanced degree of relaxation or increased refreshment.

Accordingly, a massage machine is proposed which is adapted to detect the relaxing state detection element such as pulse, body temperature and galvanic skin response, for controlling a massage mechanism in accordance with the degree of relaxation of the person [JP-A No. 6-209(1994)]. With the massage machine described, detection of the relaxation indicating factor and the control of the massage mechanism based on the detection are effected concurrently, so that the machine has the problem of failing to produce a massaging movement fully reflecting the degree of relaxation of the person to be massaged. Further the relationship between the data such as pulse, body temperature or galvanic skin response (GSR) and the senses, preferences or condition of the person to be massaged still remains to be fully substantiated, hence the problem that the machine fails to give an effective massage in conformity with varying psychological conditions of the person.

Accordingly the present applicant has proposed a massage machine which is adapted to give an effective massage in conformity with varying psychological conditions of the person [JP-A No. 2002-165853]. The massage machine comprises a physiological sensor for detecting pulse, body temperature and galvanic skin response of the person, and a control circuit for controlling the massage operation based on the physiological data detected by the physiological sensor. At first the control circuit gives a preliminary massage for estimating the psychological state of the person based on variations in physiological data detected by the physiological sensor, and thereafter gives a full massage for adjusting a massage operation in accordance with the estimated psychological state.

However, the conventional massage machine for estimating the psychological state by the preliminary massage and giving the full massage based on the estimated result needs to give the preliminary massage before the full massage having therapeutic effect, entailing the problem that the massaging time is rendered longer by a period of time required for the preliminary massage.

Even if the preliminary massage operation is performed first for estimating the psychological state of the person to be massaged, the psychological state of the person will be varied every second by therapeutic effect of the full massage. Accordingly for the first half of the full massage, the massage operation is performed effectively with the reflection of the psychological state of the person, while for the second half of the full massage, the psychological state of the person is thereafter varied to thereby fail to produce a massage operation fully reflecting the true psychological state of the person, entailing the problem of the reduction in massaging effect.

### SUMMARY OF THE INVENTION

A first object of the present invention is to provide a massage machine which is capable of achieving a satisfactory massaging effect within a shorter period of massaging time than conventionally. A second object of the present invention is to provide a massage machine which performs a massage operation effectively in accordance with the progress of the massaging therapy.

A first massage machine of the present invention comprises a physiological sensor for detecting physiological data of a person to be massaged, and a control circuit for controlling a massage operation based on the physiological data detected by the physiological sensor.

The control circuit comprises psychological state estimating means for estimating the psychological state of the person to be massaged based on the physiological data detected by the physiological sensor by an execution of a preliminary massage, and massage operation adjusting means for adjusting a full massage operation in accordance with the estimated psychological state. For the preliminary massage, one typical massage movement is performed from among a plurality of kinds of massage movements to be performed for the full massage, to detect variations of the physiological data.

The massage machine of the present invention is so adapted that the one typical massage movement needs only to be performed as for the preliminary massage unlike another massage machine performing all of the plurality of kinds of massage movements for the preliminary massage. A period of time required for one time preliminary massage is therefore shortened, with the result that a period of time from the start of massage until the completion thereof is made shorter than conventionally. Incidentally since the typical massage movement is performed for the preliminary massage, the psychological state of the person is approximately accurately detected, whereby the full massage can produce a satisfactory therapeutic effect.

Stated specifically, one kind of massage movement is selected as the one typical massage movement so as to produce a psychological state which is closest to the state wherein all of a plurality of kinds of massage movements to be performed for the full massage are consecutively performed. Accordingly the psychological state is detected with the same accuracy as in the case where the plurality of kinds of massage movements are performed for the preliminary massage. As a result the full massage will produce a high therapeutic effect comparable to that produced when the plurality of kinds of massage movements are performed for the preliminary massage.

With a second massage machine of the present invention, a control circuit comprises psychological state estimating means for estimating psychological state of the person to be massaged based on physiological data detected by a physiological sensor by execution of a preliminary massage, and massage operation adjusting means for adjusting a full massage operation in accordance with the estimated psychological state. The person to be massaged is given a massage therapy by alternately repeating the preliminary massage and full massage.

With the massage machine of the present invention, the preliminary massage is not only performed prior to the full massage, but is performed during a sequence of the full massage. The massage machine is therefore adapted to produce the full massage fully reflecting variations of the psychological state of the person with the progress of the full massage, so that the massage operation is executed based on the true psychological state of the person to be massaged, with the result that the higher massage effect is obtained than conventionally. Although one time preliminary massage is executed by performing massage operations on all parts to be massaged for the full massage, this is not limitative; one time preliminary massage is executed by performing a massage operation on one of the parts to be massaged for the full massage, and a part to be massaged is switched every preliminary massage. This makes it possible to shorten a period of time required for performing one time preliminary massage.

Furthermore, although one time full massage is performed by executing all kinds of massage movements to be executed for the full massage, this is not limitative; one time full massage is executed by performing one kind of massage movement from all kinds of massage movements to be performed for the full massage, and a kind of massage movement is switched every full massage. This makes it possible to estimate the psychological state more frequently by the execution of the preliminary massage.

A third massage machine of the present invention comprises a sensor for detecting physiological data of a person to be massaged, and performs a massage operation by moving massage balls based on a detected value of the sensor. The massage machine comprises:

means for performing a preliminary massage operation for an area to be massaged,

means for estimating a position of an area to be massaged and of shoulders, back, and/or waist, and a position of a point of Shiatsu, i.e., a point which is to be given Shiatsu or finger pressure therapy, within each area to be massaged,

means for judging sensation of stiffness for each area to be massaged based on a value of the sensor detected when the preliminary massage operation is performed for each area to be massaged,

means for judging sensation of stiffness for each point of Shiatsu based on a value of the sensor detected when the preliminary massage operation is performed for each point of Shiatsu within the area to be massaged, and

means for performing a massage operation for each point of Shiatsu based on the sensation of stiffness judged for each area to be massaged, and the sensation of stiffness judged for each point of Shiatsu within the area to be massaged.

With the massage machine of the present invention, the massage operation is determined based on the judging result of the sensation of stiffness in the event of the preliminary massage performed for each area to be massaged, and the judging result of the sensation of stiffness in the event of the preliminary massage performed for each point of Shiatsu within each area to be massaged, so that more appropriate massage operation is performed for each point of Shiatsu.

The present invention provides a massage method for a massage machine to perform a massage, the massage machine for performing a massage operation by moving massage balls based on a value detected by a sensor for detecting physiological data of the person to be massaged, the massage method of performing a preliminary massage operation for an area to be massaged and of shoulders, back and/or waist, with gentler movement of the massage balls than said movement of the massage balls based on the value detected by the sensor, the massage method of estimating a position of an area to be massaged and of shoulders, back, and/or waist, and a position of a point of Shiatsu, i.e., a point which is to be given Shiatsu or finger pressure therapy, within each area to be massaged, the massage method of judging sensation of stiffness for each area to be massaged based on the value of the sensor detected when the preliminary massage operation is performed for each area to be massaged, the massage method of performing the preliminary massage operation for each point of Shiatsu within each area to be massaged with gentler movement of the massage balls than said movement of the massage balls based on the value detected by the sensor, and judging sensation of stiffness for each point of Shiatsu based on a detected value of the sensor, the massage method of performing a massage operation for each point of Shiatsu based on the sensation of stiffness judged for each area to be massaged and the sensation of stiffness judged for each point of Shiatsu within each area to be massaged.

The massage method can realize so-called “low-impact” massage therapy, such that resistance force against stimulus will not unconsciously be imposed in the body.

### BRIEF DESCRIPTION OF THE DRAWINGS

FIG. 1 is a perspective view of a massage machine of the first embodiment of the present invention during use;

FIG. 2 is a rear view showing the construction of the massage mechanism;

FIG. 3 is a rear view showing the construction of a massage ball drive device;

FIG. 4 is a block diagram showing the construction of a control system of the massage machine;

FIG. 5 is a perspective view showing the appearance of a remote controller;

FIG. 6 is a flowchart showing an operation of the massage machine of the first embodiment of the present invention;

FIG. 7 is a chart showing a sequence example of a full massage in the operation of the massage machine;

FIG. 8 is a flowchart showing another operation of the massage machine of the first embodiment of the present invention;

FIG. 9 is a flowchart of part of FIG. 8;

FIG. 10 is a chart showing a sequence example of the full massage in the operation described;

FIG. 11 is a chart showing a result of an experience for setting a typical massage movement from among a plurality of kinds of massage movements;

FIG. 12 is a chart showing the relationship for estimating a psychological state based on physiological data;

FIGS. 13(a) and 13(b) are charts showing rules for altering the massage time and the massage speed in accordance with the mode and the psychological state in the full massage operation;

FIG. 14 is a rear view showing the construction of a massage ball drive device for use in the massage machine of the second embodiment of the present invention;

FIG. 15 is a side elevation showing the construction of a thrusting-up mechanism provided with the massage machine;

FIG. 16 is a side elevation showing the specific construction of the thrusting-up mechanism;

FIG. 17 is a block diagram showing the construction of a control system for use in the massage machine of the second embodiment;

FIG. 18 is a flowchart showing a first half of a massage procedure performed by the massage machine of the second embodiment;

FIG. 19 is a flowchart showing a second half of a massage procedure performed by the massage machine of the second embodiment;

FIG. 20 is a diagram illustrating “loosening-up movement” and “rubbing movement” which are to be performed by the massage machine of the second embodiment;

FIG. 21 is a diagram showing a procedure of determining the frequency of Shiatsu which is set in accordance with a judging result for an area to be massaged in the case of the massage machine of the second embodiment;

FIGS. 22(a) and 22(b) are graphs showing the relationship between the frequency of Shiatsu and the sensation of stiffness, and the relationship between amount of thrusting-up of the massage ball and the sensation of stiffness.

### DETAILED DESCRIPTION OF EMBODIMENTS

First Embodiment

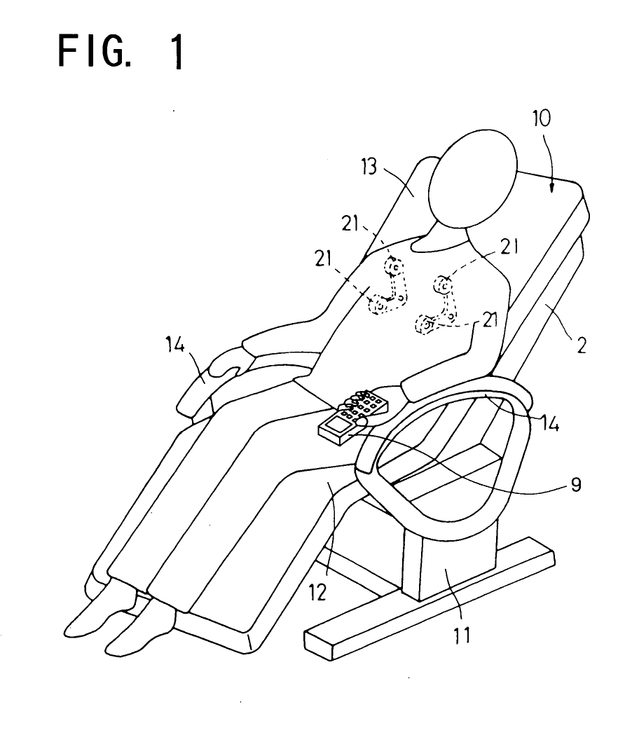

With reference to FIG. 1, the massage machine of the present embodiment comprises a chair body 10 including legs 11, seat 12, backrest 13 and a pair of opposite armrests 14, 14, and a massage mechanism 2 having a plurality of massage balls 21 and incorporated into the chair body 10. The machine gives a massage to the human body by reciprocatingly moving the massage balls 21 up and down while vibrating these balls 21.

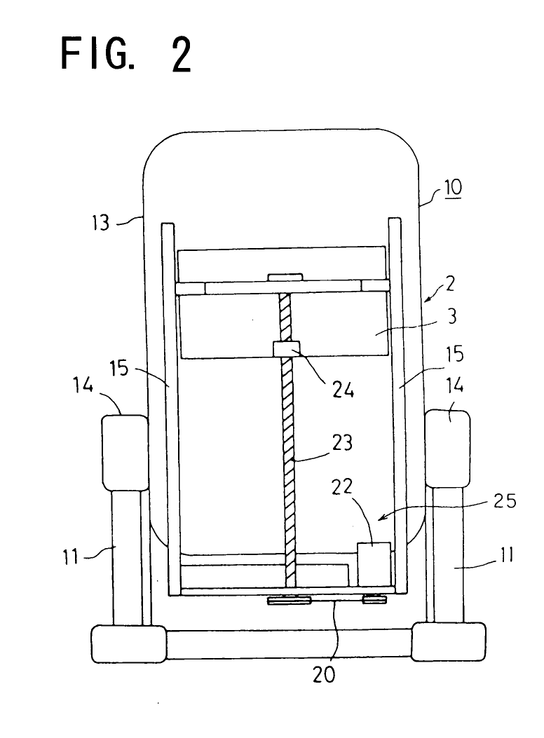

With reference to FIG. 2, the massage mechanism 2 has a massage ball drive device 3 provided on the back of the backrest 13 of the chair body 10 for vibrating the massage balls. The drive device 3 is supported by side frames 15, 15 attached to the back side of the backrest 13 and is movable upward and downward. The chair body 10 is provided with an up-down motor 22 for moving the massage balls 21 upward and downward. The up-down motor 22 is coupled to a screw rod 23 by a belt power transmission mechanism 20. The screw rod 23 is in screw-thread engagement with a bearing 24 attached to the drive device 3. Accordingly, when the screw rod 23 is rotatingly driven by the up-down motor 22, the drive device 3 is moved upward and downward with this movement.

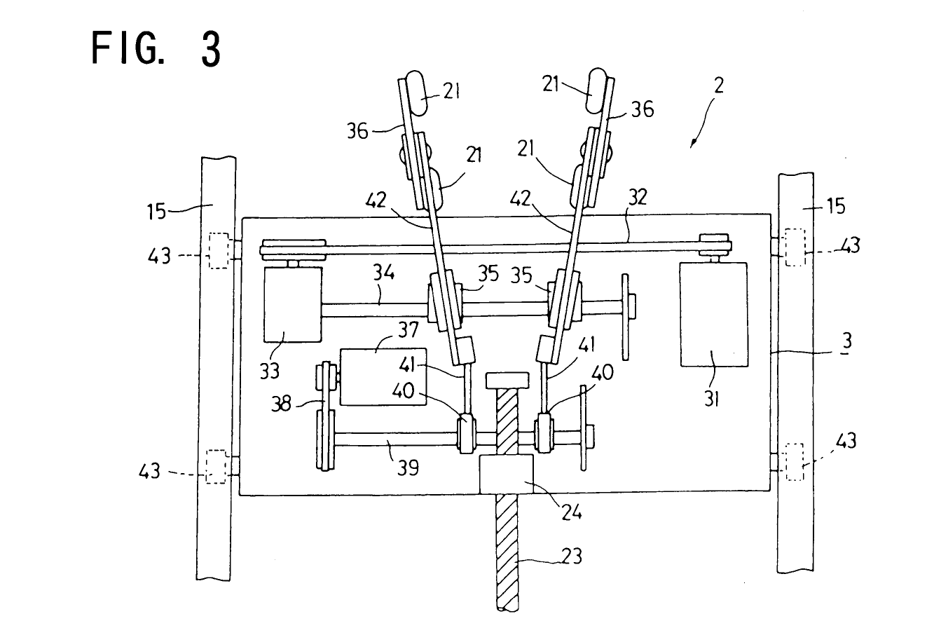

With reference to FIG. 3, the massage ball drive device 3 has a plurality of rollers 43, 43 at opposite sides. These rollers 43, 43 are in engagement with the side frames 15, 15 for guiding the drive device 3 for upward and downward. The drive device 3 is provided with a kneading motor 31, which is coupled to a shaft 34 by way of a belt power transmission mechanism 32 and a speed change mechanism 33. The shaft 34 has mounted thereon a pair of opposite eccentric bearings 35, 35 for supporting a pair of opposite support arms 42, 42. Pivoted to the outer end of each support arm 42 is a generally L-shaped pivotal arm 36. Massage balls 21, 21 are rotatably mounted on opposite ends of the pivotal arm 36.

The shaft 34, when drivingly rotated by the kneading motor 31, pivotally drives the support arms 42, 42 toward or away from each other to thereby realize a kneading movement by the massage balls 21, 21.

The drive device 3 has a tapping motor 37, which is coupled to a shaft 39 by a belt power transmission mechanism 38. A pair of opposite eccentric bearings 40, 40 are mounted on the shaft 39 for supporting a pair of opposite rods 41, 41. The outer ends of the rods 41 are connected to the base ends of the respective arms 42. Accordingly, when rotatingly driven by the tapping motor 37, the shaft 39 pivotally drives the rods 41, 41 forward or rearward to thereby realize a tapping movement by the massage balls 21, 21.

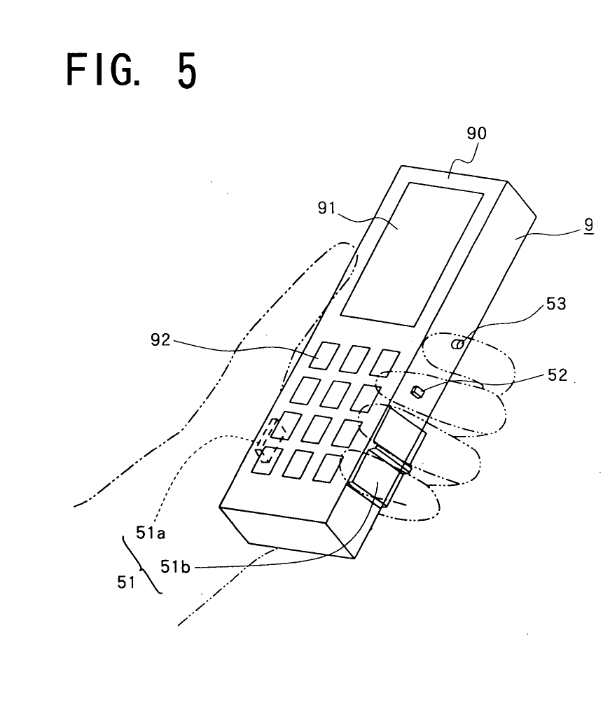

The massage machine of the present invention can be operated by manipulating a remote controller 9 as shown in FIG. 1. With reference to FIG. 5, the remote controller 9 comprises a display 91 and a plurality of manual buttons 92 arranged on the front side of a vertical casing 90. Arranged on the right side face of the casing 90 are a pulse sensor 52 comprising a light-emitting element and light-receiving element, and a skin temperature sensor 53 comprising a thermistor. A-GSR sensor 51 comprising a pair of electrodes 51a, 51b is disposed on opposite side faces of the casing 90. When the controller 9 is grasped with the left hand as indicated in chain lines, the forefinger comes into contact with the skin temperature sensor 53, the middle finger with the pulse sensor 52, the ring finger and the little finger with the electrode 51b of the GSR sensor 51 and the palm with the other electrode 51a of the GSR sensor 51.

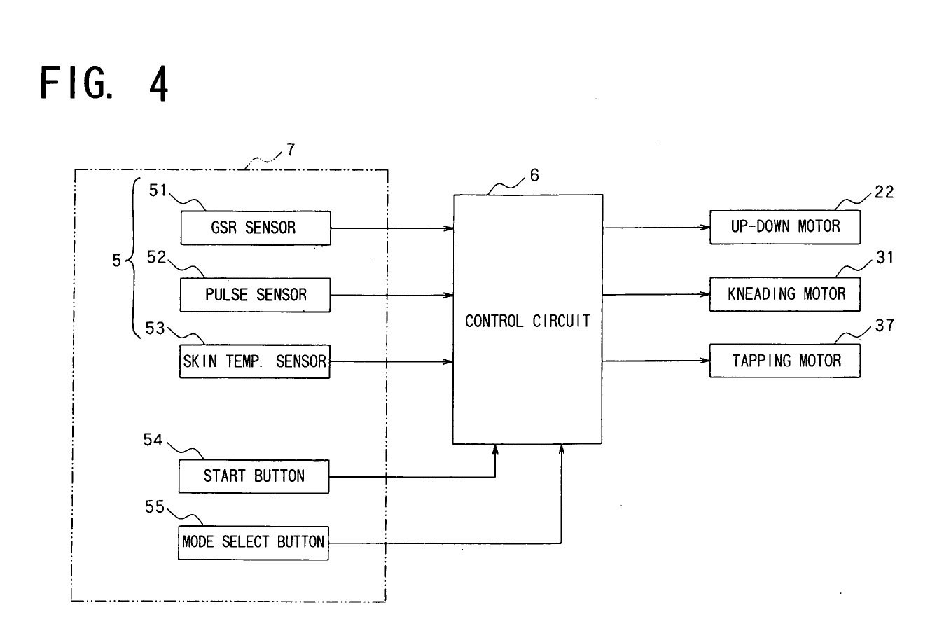

FIG. 4 shows the construction of a control system for the massage machine. A physiological sensor 5 comprising the GSR sensor 51, pulse sensor 52 and skin temperature sensor 53 is connected to input ports of a control circuit 6 comprising a microcomputer. Also connected to other input ports of the control circuit 6 are a start button 54 to be depressed for starting a massage operation, and a mode select button 55 to be depressed for switching between a relaxation mode and a refreshment mode. Connected to output ports of the control circuit 6 are the aforementioned up-down motor 22, kneading motor 31 and tapping motor 37.

When the start button 54 is depressed, the control circuit 6 is operated in the mode selected by the mode select button 55, to execute first the preliminary massage procedure to be described below based on the signal from the physiological sensor 5 and thereafter perform the full massage procedure to be described later.

It is known that the relationship between the physiological data detected by the physiological sensor S, i.e., GSR, skin temperature and pulse rate and the psychological state of the person to be massaged (user) is as will be described below [see JP-A No. 2002-165853]. The GSR, skin temperature and pulse rate vary in different modes with the degree of activity of the autonomic nervous system. When the degree of activity is low, GSR and pulse rate lower and the skin temperature rises. When the degree of activity is slightly low, GSR remains unchanged, but the skin temperature rises and the pulse rate drops. If the degree of activity is slightly high, GSR rises from the constant level, the skin temperature lowers and the pulse rate rises. Further when the degree of activity is high, GSR greatly rises, the skin temperature drops and the pulse rate increases.

As the psychological states of the user in the event of such variations in the physiological data, it is speculated that the user is in a relaxed comfortable state when the degree of activity is low, or that the user feels such a unique sensation as is experienced when massaged at a stiff part, feeling both pain and comfort as mingled therewith, when the degree of activity is slightly high, or that the user feels a pain when the degree of activity is high. When the degree of activity is neutral, the user will presumably be in a neutral state, feeling neither comfort nor pain.

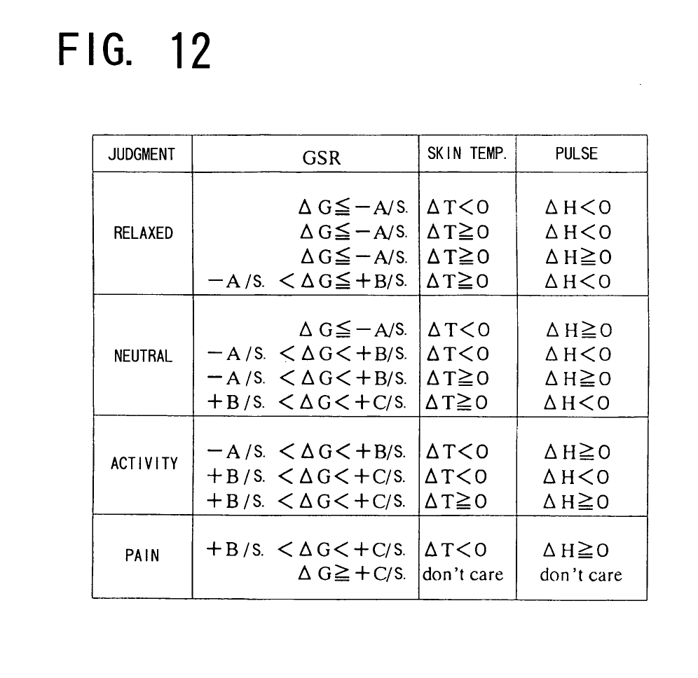

FIG. 12 shows the estimation of psychological states based on the aforementioned relationship as formulated, to determine “pain,” “active,” “neutral” or “relaxed” from combinations of GSR variations ΔG, skin temperature variations ΔT and pulse rate variations ΔH. Accordingly the psychological state of the user can be estimated by detecting variations in GSR, skin temperature and pulse rate while giving various massages to parts of the user for the preliminary massage. Subsequently for the full massage, the user can be massaged according to his or her preference by recognizing the user's preference in the kind of massage for various parts from the psychological state of the user.

For the full massage operation, various massage movements (tapping, kneading, rolling, etc.) are consecutively performed on various parts (shoulders, back, waist, legs). The time (duration) and frequency of each massage movement are adjusted according to the selected mode (relaxation mode or refreshment mode) and the psychological state estimated by the preliminary massage.

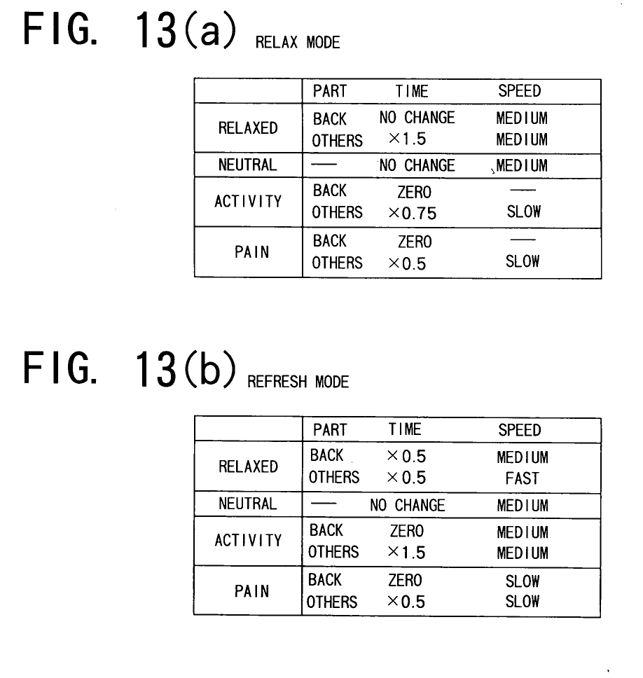

FIGS. 13(a) and 13(b) show rules for adjusting the massage time and the massage speed in accordance with the psychological state in the relaxation mode and the refreshment mode, respectively. For example when the psychological state is estimated to be “relaxed” in the case where the relaxation mode is selected, the massage time for the parts other than the back is extended, with the massage speed held at medium level. The particulars for others are as listed in FIG. 13(a). In this way, an improved degree of relaxation will be achieved.

When the psychological state is estimated to be “active (both pain and comfort)” in the case where the refreshment mode is selected, the massage time for the parts other than the back is extended, with the massage speed held at medium level. The particulars for others are as listed in FIG. 13(b). In this way, an improved degree of refreshment will be achieved.

For the conventional preliminary massage, all kinds of the massage movements to be performed for the full massage are performed on all the parts. However, for the preliminary massage of the present invention, only one kind of typical massage movement is performed.

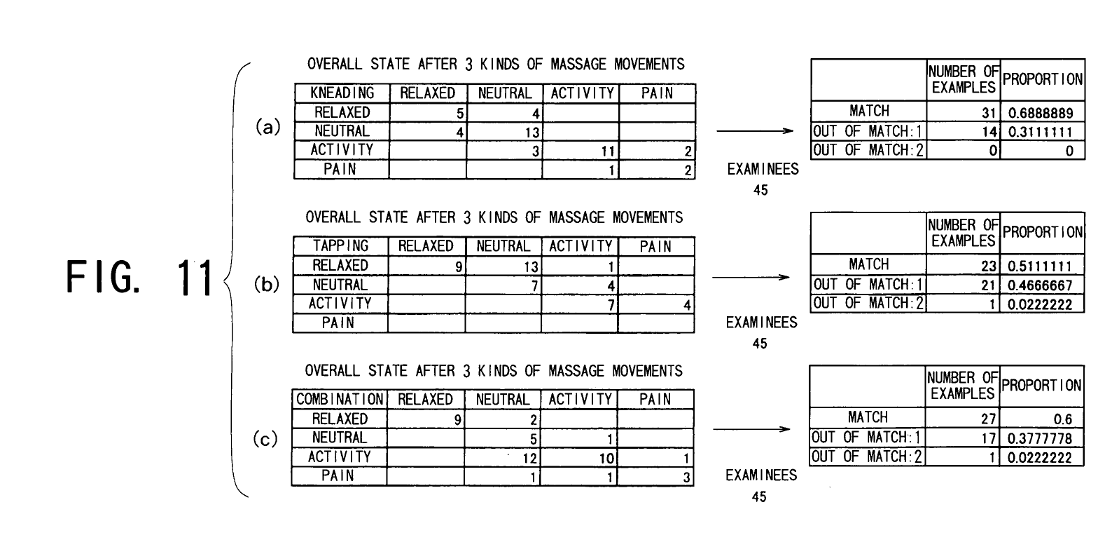

FIG. 11 shows the result of an experiment conducted to select one kind of typical massage movement from among a plurality of massage movements. For the experiment, forty-five persons were consecutively given three kinds of massages (kneading, tapping, combination of these movements) and asked for the psychological state (relaxed, neutral, activity, pain) as recognized subjectively by themselves, while the examinees were given one kind of massage from the above three kinds of massages and asked for the psychological state as recognized subjectively. Matrices seen in FIG. 11 show the match/out of match between the above two different conditions in the experiment.

For each of matrices shown in FIGS. 11(a), (b) and (c), the psychological states (overall state) in the event of the three kinds of massages given are used to enter the horizontal axis, respectively, while the psychological states in the event of only one kind of massage given from among “kneading”, “tapping”, “combination of these movements” are used to enter the vertical axis, respectively. Plotted on the crossing point of the matrix is the number of the corresponding examinees given the experiment.

For the matrix of “kneading” shown in FIG. 11(a), the number of examples wherein the psychological states of the horizontal axis is in match with those of the vertical axis are 31. In this case the proportion in total number 45 is 0.69, which is the greatest. For the matrix of “combination of tapping and kneading” shown in FIG. 11(c), the match proportion is 0.6, which is in the second place. For the matrix of “tapping” shown in FIG. 11(b), the match proportion is 0.51, which is the smallest. According to this result, the psychological states in the event of only “kneading movement” performed are closest to the psychological states in the event of all of “kneading,” “tapping,” and “combination of these movements” performed. “Kneading” is therefore the typical massage movement.

Consequently, for the preliminary massage, if “kneading” is only performed from among the three kinds of massage movements to be executed for the full massage, the psychological states to be estimated will be approximately in match with those in the event of all of the three massage movements performed consecutively.

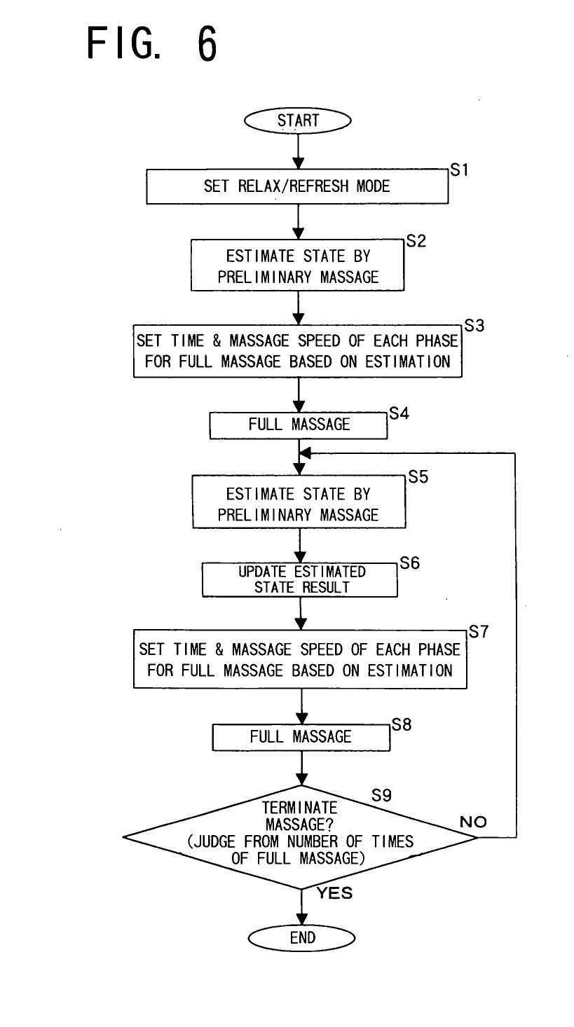

FIG. 6 shows a series of operations performed by the massage machine of the present invention. First in step S1 in response to user's selecting manipulation, the relaxation mode or refreshment mode is set. In step S2 the preliminary massage is performed for estimating the psychological state. For the preliminary massage, only the aforementioned typical massage movement (kneading) is performed on all the parts (shoulders, back, waist).

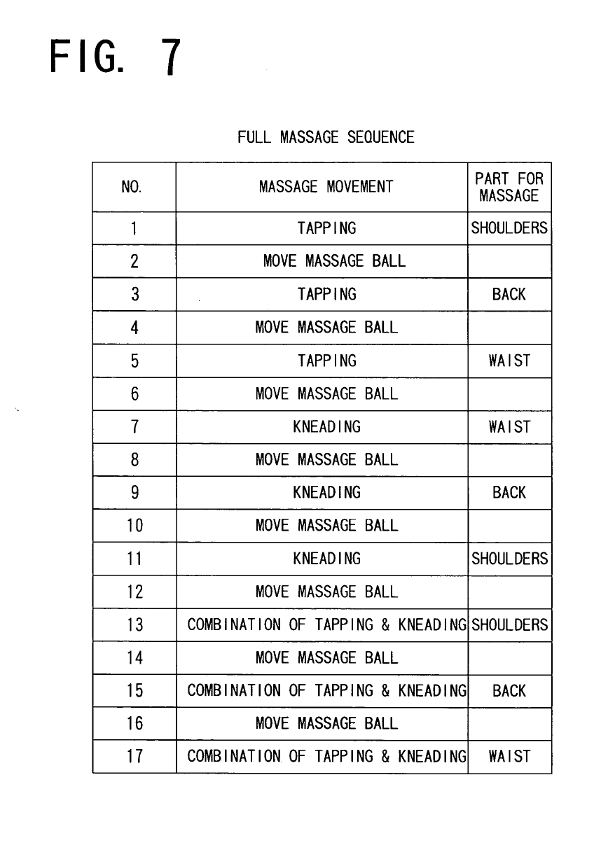

Based on the result of psychological state estimation, time and massage speed of each phase constituting the massage operation of the full massage are set in step S3, and the full massage is performed in step S4. FIG. 7 shows a sequence example of the full massage. Subsequently in step S5 shown in FIG. 6, the preliminary massage (kneading only) is performed to estimate the psychological state again. In step S6, the result of psychological state estimation is updated. Based on the result of psychological state estimation, the time and the massage speed of each phase constituting the massage operation of the full massage are set in step S7, followed by step S8 wherein the full massage is performed.

An inquiry is thereafter made as to whether the massage is to be terminated depending on whether the frequency of the full massages is greater than a predetermined value in step S9. If the inquiry is answered in the negative, the sequence returns to step S5 to repeat the estimation by the preliminary massage and the full massage based on the result of estimation. When the frequency of the full massages becomes greater than the predetermined value, a series of massages are terminated.

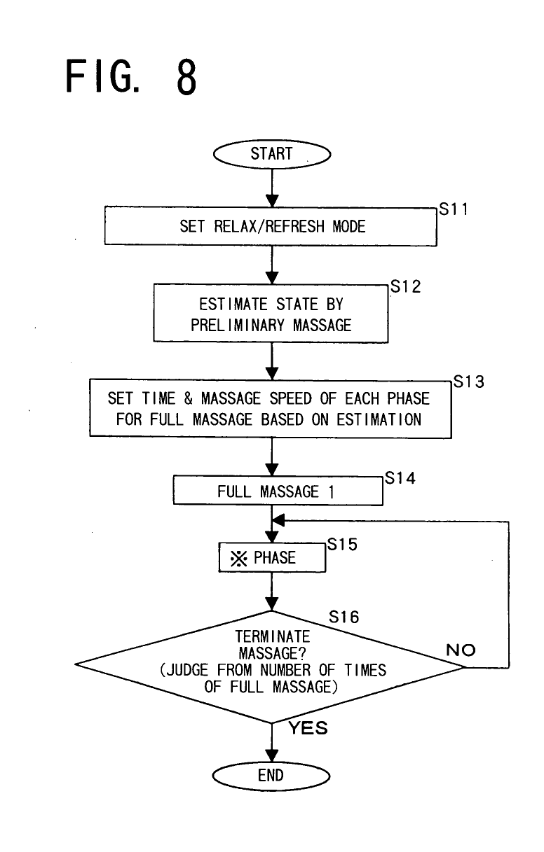

Furthermore FIG. 8 shows another example of massage operation performed by the massage machine of the present invention. First in step S11, in response to user's manipulation, the relaxation mode or refreshment mode is set. In step S12 the preliminary massage is performed to estimate the psychological state. For the first preliminary massage, only the typical massage movement (kneading) is performed on all the parts (shoulders, back, waist).

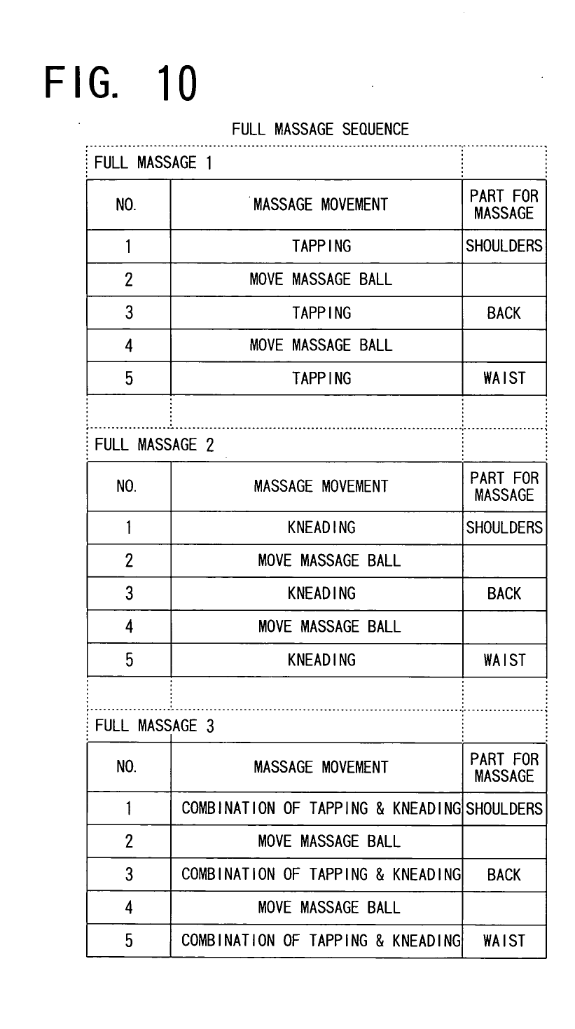

Based on the result of psychological state estimation, the time and the massage speed of each phase constituting the massage operation of the full massage are set in step S13, and the full massage-1 is performed in step S14. FIG. 10 shows a sequence example of the full massage-1.

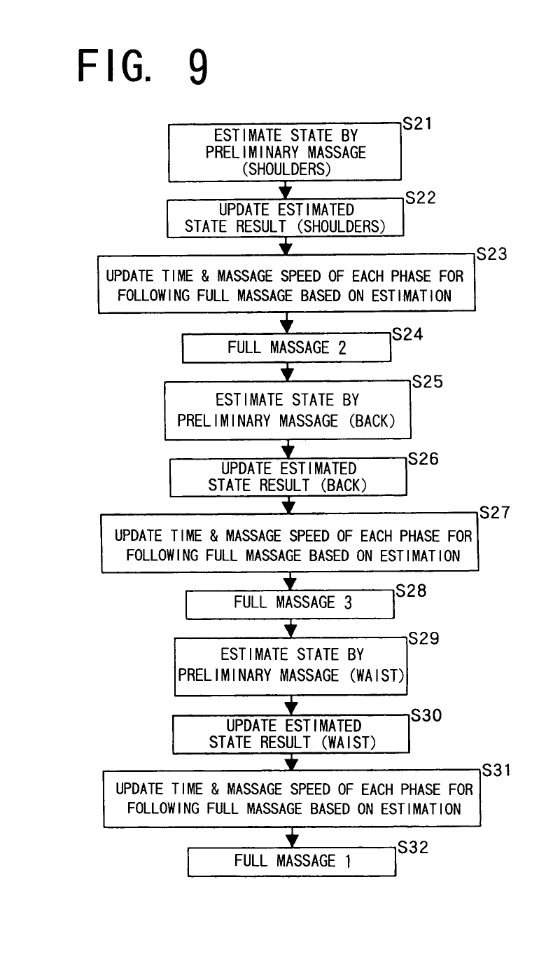

Subsequently the sequence proceeds to phase operation in step S15 as shown in FIG. 8. In the phase operation, the preliminary massage (kneading only) is performed on to the shoulders to estimate the psychological state in step S21 as shown in FIG. 9. In step S22, the result of psychological state estimation for the shoulders is updated. Based on the updated result of psychological state estimation, the time and the massage speed of each phase constituting the massage operation of the full massage are set in step S23, followed by step S24 wherein the full massage-2 is performed. FIG. 10 shows a sequence example of the full massage-2.

The preliminary massage (kneading only) is thereafter performed on to the back to estimate the psychological state in step S25 as shown in FIG. 9. In step S26, the result of psychological state estimation for the back is updated. Based on the updated result of psychological state estimation, the time and the massage speed of each phase constituting the massage operation of the full massage are set in step S27, followed by step S28 wherein the full massage-3 is performed. FIG. 10 shows a sequence example of the full massage-3.

The preliminary massage (kneading only) is thereafter performed on to the waist to estimate the psychological state in step S29 as shown in FIG. 9. In step S30, the result of psychological state estimation for the waist is updated. Based on the updated result of psychological state estimation, the time and the massage speed of each phase constituting the massage operation of the full massage are set in step S31, followed by step S32 wherein the full massage-1 is performed again.

An inquiry is thereafter made as to whether the massage is to be terminated depending on whether the frequency of the full massages is greater than a predetermined value in step S16 shown in FIG. 8. If the inquiry is answered in the negative, the sequence returns to step S15 to repeat the aforementioned phase operation (the estimation by the preliminary massage, the execution of the full massage based on the estimated result). When the frequency of the full massages becomes greater than the predetermined value, a series of massages are terminated.

The massage machine of the present invention is so adapted that the one typical massage movement needs only to be performed as for the preliminary massage unlike another massage machine performing all of the plurality of kinds of massage movements for the preliminary massage. A period of time required for one time preliminary massage is therefore shortened, with the result that a period of time from the start of massage until the completion thereof is made shorter than conventionally. Incidentally the typical massage movement is performed as for the preliminary massage, so that the psychological state is detected with the same accuracy as in the case where the plurality of kinds of massage movements are performed for the preliminary massage. As a result the full massage will produce the same high therapeutic effect comparable to that in the event of the plurality of kinds of massage movements performed for the preliminary massage.

With the massage machine of the present invention, the preliminary massage is not only performed prior to the full massage, but is performed during a sequence of the full massage. The massage machine is therefore adapted to perform the full massage fully reflecting variations of the psychological state of the person with the progress of the full massage, so that the massage operation is executed based on the true psychological state of the person to be massaged, with the result that the higher massage effect is obtained than conventionally.

Furthermore, with the massage operations shown in FIGS. 8 and 9, the preliminary massages repeated during the full massage are performed on to one part, respectively, so that the time required for one time preliminary massage is more shortened. Since the part to be given a preliminary massage is successively switched, the data on the psychological states can be obtained from all the parts from viewpoints of the whole massage operation, whereby effective full massage can be performed.

Brain waves of the user are usable as physiological data for estimating the psychological state. The brain waves are measured during the massage operation, for example, when waveforms (a wave) of 8 to 13 Hz are detected based on frequency data of the brain wave, the psychological state of the user is presumably in the relaxing mode.

Second Embodiment

The massage machine of the present embodiment has the same construction as that of the first embodiment shown in FIGS. 1 and 2. The massage balls 21 are reciprocatingly moved up and down, are vibrated, and are moved in a circular or elliptical orbit, to thereby give massage to the user.

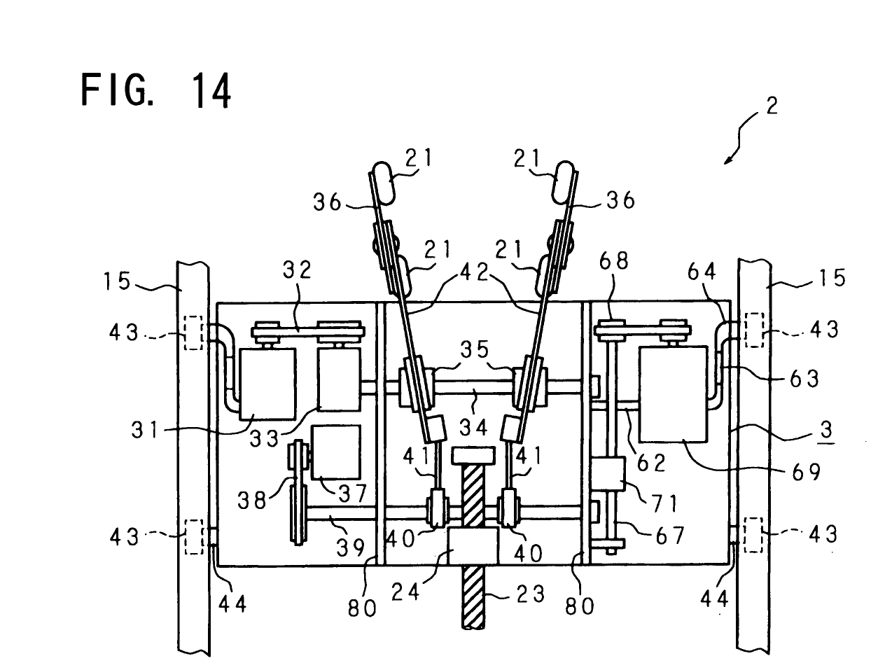

FIG. 14 shows the construction of a massage ball drive device 3 for use in the massage machine of the present embodiment. Throughout the drawing, like parts which are the same components as of the massage ball drive device of the First Embodiment will be designated by like reference numerals. The massage ball drive device 3 is supported by an axis of rotation 44 supported between rollers 43, 43 which are near to lower ends. The massage ball drive device 3 is also supported by a crankshaft 62 for a thrusting-up mechanism 60 as will be described below, through a crankpin 64 and a crank arm 63 between the rollers 43, 43 which are near to upper ends. As will be described in detail, the crankshaft 62 is rotated by driving a thrusting-up motor 69, causing the massage mechanism 2 to turn about the axis of rotation 44 which supports a lower part, to thereby move the massage ball 21 forward or rearward, i.e., toward or away from the body of the user.

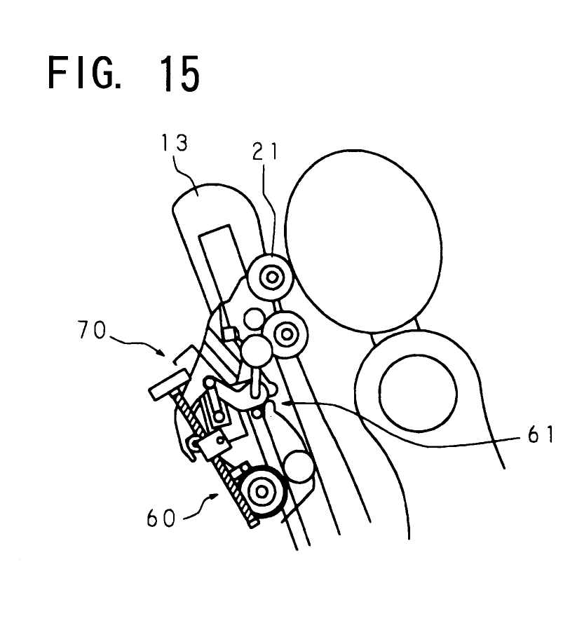

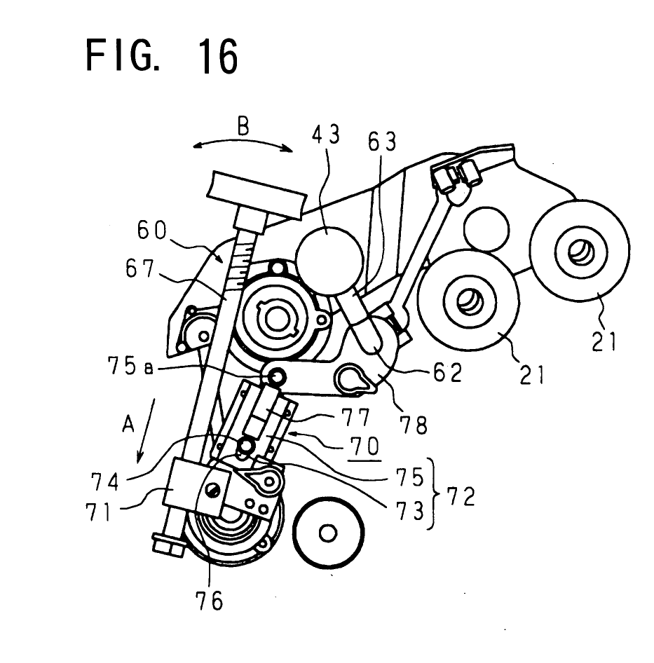

FIGS. 15 and 16 show the construction of the thrusting-up mechanism 60 which is provided with the massage machine of the present invention. The massage mechanism 2 has incorporated therein the thrusting-up mechanism 60 which moves toward or away from the body of the user sitting on a seat 12. Shiatsu or finger pressure therapy can be performed by moving the massage mechanism 2 toward the body of the user because of the thrusting-up mechanism 60, and the adjustment of amount of thrusting-up makes it possible to alter the degree (strong/weak) in contact of the massage ball 21 toward the body of the user, whereby the machine achieves a highly effective massage.

With the thrusting-up mechanism 60, a crank mechanism 61 and link mechanism 70 are driven by the thrusting-up motor 69 as shown in FIG. 16, to thereby move the massage mechanism 2 forward or rearward, as will be specifically described below. The crank mechanism 61 comprises a crankshaft 62 provided forward of the aforementioned shaft 34 for kneading and a crankpin 64 fitted into upper rollers 43, 43 rotatably, which are connected at opposite ends of the crankshaft 62 by a crank arm 63. Since the crankpin 64 is eccentric to the crankshaft 62, the rotation of the crankshaft 62 causes the crankpin 64 to move in circular orbit about the crankshaft 62.

Bearings (not shown) are attached to an auxiliary frame 80 at two positions of upper and lower sides, respectively. A screw axis 67 which is screw-cut on a center is supported by the bearing. Rotating force from the thrusting-up motor 69 is transmitted to an upper end of the screw axis 67 through deceleration device 68 including a pulley and a belt.

The screw axis 67, at its screw-cut center, is in screw-thread engagement with a nut member 71. The nut member 71 is connected to a link 72 comprising a first and second link pieces 73, 75. The first link piece 73 is supported to the nut member 71 tiltably forward or rearward. A slide axis 74 is provided in the vicinity of the first link piece 73 at its base end. On the other hand, the second link piece 75 comprises a pair of members holding the first link piece therebetween, and has a long opening 76 provided longitudinally. The slide axis 74 of the first link piece 73 is slidably fitted around the long hole 76 of the second link piece 75.

The second link piece 75 has an axis 75a provided at its end portion. A coil spring 77 extends between the slide axis 74 and the axis 75a. The second link piece 75 is biased by the coil spring 77 into the nut member 71. With no load condition, the second link piece 75 is drawn maximally to the nut member 71 by the coil spring 77.

A third link piece 78 is supported by the axis 75a of the second link piece 75. The third link piece 78 has a center portion bent forward, and an end portion fixed to the crankshaft 62.

Accordingly, with the nut member 71 positioned at an upper side of the screw axis 67, the third link piece 78 is drawn toward the second link piece 75, and the massage mechanism 2 is therefore drawn most downward, i.e., is positioned most away from the body of the user. From this position, the screw axis 67 is rotated by driving the thrusting-up motor 69, to thereby move the nut member 71 toward the lower side (in a direction indicated by an arrow A in FIG. 16), to cause the second link piece 75 to draw downward an engagement portion with the third link piece 78 with the movement of the nut member 71, whereby the third link piece 78 is rotated about the crankshaft 62. In this case the crankshaft 62 and the third link piece 78 are rotated together since the third link piece 78 is fixed to the crankshaft 62.

The crankshaft 62 has opposite ends connected to the roller 43 by the crankpin 64, so that the crankshaft 62 is movable only along the side frame 15, i.e., only in an upward or downward direction. The massage mechanism 2 is therefore tilted about an axis of rotation 44 by the rotation of the crank axis 62. The axis of rotation 44 supports the lower part of the massage mechanism 2, so that, as the massage mechanism 2 is tilted in a direction indicated by an arrow B of FIG. 16, the massage balls 21 move forward or backward, i.e., toward or away from the body of the user.

For example, when the massage balls 21 thrust up around the shoulder by the thrusting-up mechanism 60, the massage balls 21 reach the upper part of the shoulder to give an effective massage to the upper part of the shoulder. Further when massage balls 21 thrust up on the back or waist which is positioned lower than the shoulder, the back or waist of the user can be given a Shiatsu massage. With this state, the massage mechanism 2 is moved upward and downward, whereby the massage balls 21 are intensely pressed against the back of the user to give a so-called rolling massage.

On the other hand, the thrusting-up motor 69 is driven to cause the screw axis 67 to rotate in opposite, moving the nut member 71 toward the upper side, to cause the massage mechanism 2 to move rearward, i.e., toward or away from the body of the user, as is the reverse case to the described, whereby the massage ball 21 is drawn back into the backrest 13. With this state, the massage machine can give a massage as conventionally. Furthermore, the amount of thrusting-up of the massage mechanism 2 can be adjusted by the rotation of the screw axis 67 or, alternatively, by the adjustment of the position of the nut member 71 on the screw axis 67.

A remote controller 9, as seen in FIG. 6, is usable for controlling the massage machine of the present embodiment. The part being massaged, degree of stiffness, degree of comfort, position of the stiff part, etc. are to be shown on the display 91 of the remote controller 9.

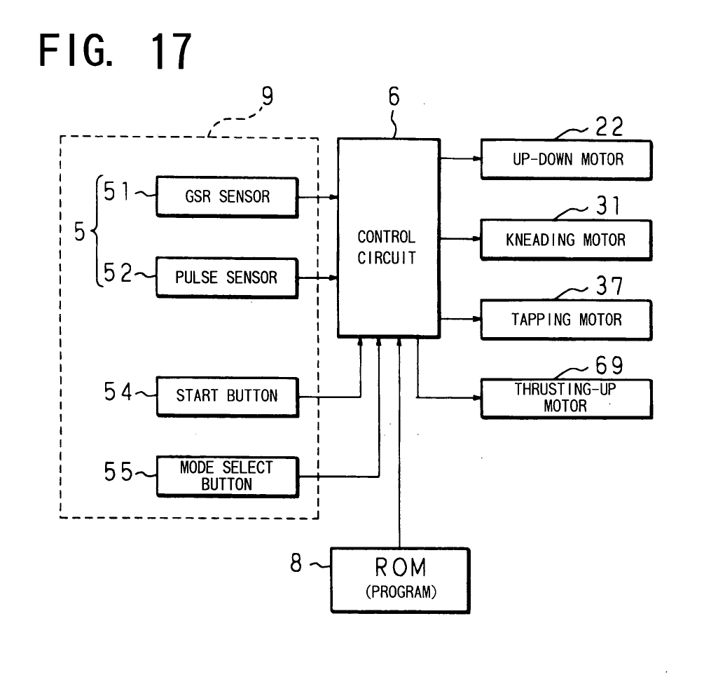

FIG. 17 shows the construction of a control system for the massage machine of the present embodiment. A physiological sensor 5 comprising a GSR sensor 51, pulse sensor 52 is connected to input ports of a control circuit 6 comprising a microcomputer. Also connected to other input ports of the control circuit 6 are a start button 54 of the remote controller 9 to be depressed for starting a massage operation, and a mode select button 55 to be depressed for switching between a relaxation mode and a refreshment mode.

Connected to output ports of the control circuit 6 are the aforementioned up-down motor 22, kneading motor 31, tapping motor 37, and the thrusting-up motor 69. Further connected to the control circuit 6 is a ROM 8, which stores, as will be mentioned below, program for describing procedures of the massage operation by the control circuit 6, and statistical data for estimating the position of the shoulders, the area to be massaged, and the point of Shiatsu. Usable instead of the ROM is memory means including hard disc, memory card, for example.

When the start button 54 is depressed, the control circuit 6 is operated in the mode selected by the mode select button 55, to execute a massage to be described below in accordance with the program stored in the ROM 8 described based on an input signal from the physiological sensor 5.

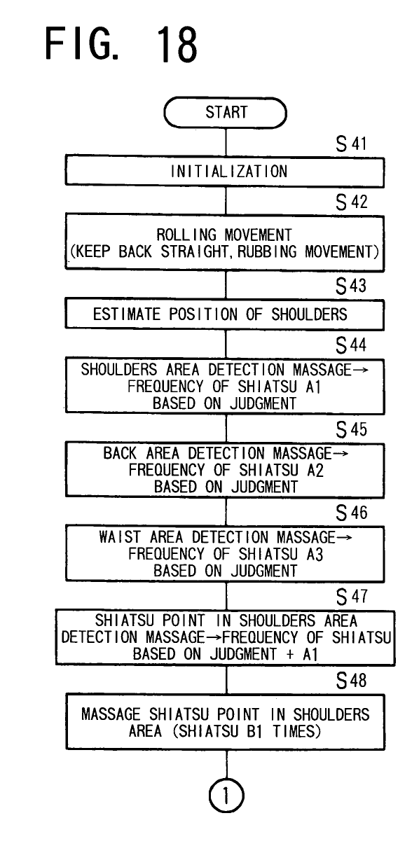

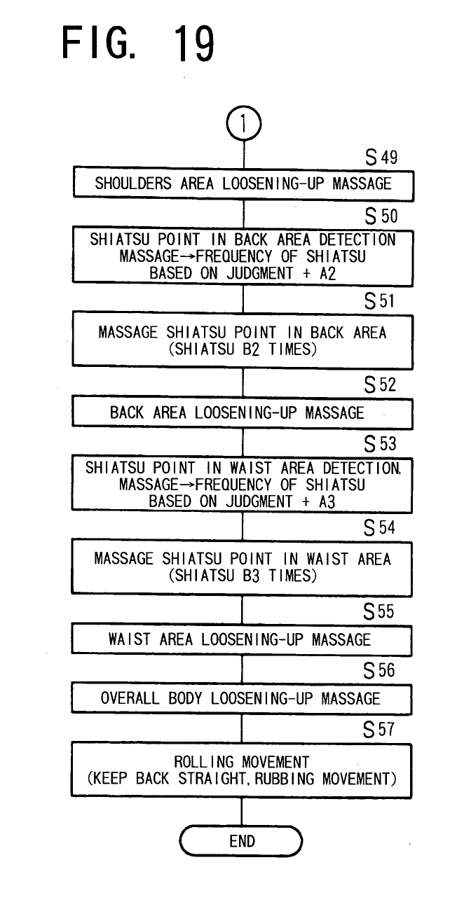

With reference to the flowchart shown in FIGS. 18 and 19, a procedure of massage executed by the massage machine of the present invention will be described below. The control circuit 6 first initializes the whole massage machine (step S41). This is a processing for returning the position of the massage balls 21, for example, to an initialized position. Subsequently the control circuit 6 performs a rolling operation (step S42), and thereafter estimates the position of the shoulders of the user (step S43). In this case the rolling operation gives the therapy to the seated user by keeping the back straight and performing a rubbing movement.

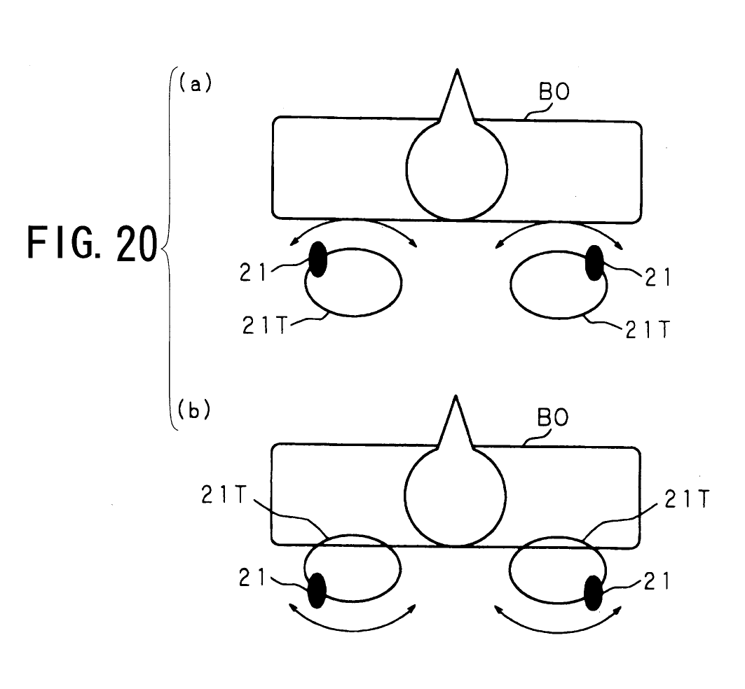

FIG. 20(a) shows the state of the massage balls 21 in movement when the massage machine of the present invention performs a “loosening-up movement.” For the “loosening-up movement,” the massage balls 21 are reciprocatingly movable in orbit, i.e., almost half of an elliptical (or circular) path (21T) which is closer to a human body BO and wherein a major axis is parallel to a surface of back of the human body BO. Accordingly the massage balls 21 reciprocatingly move in orbit which protrudes against the surface of back of the human body, and press the muscle, to thereby achieve a kneading and loosening-up effect on muscle.

FIG. 20(b) shows the state of the massage balls 21 in movement when the massage machine of the present invention performs a “rubbing movement.” For the “rubbing movement,” the massage balls 21 are reciprocatingly movable in orbit, almost half of an elliptical (or circular) path (21T) which is away from a human body BO and wherein a major axis is parallel to a back of surface of the human body BO. The massage balls 21 reciprocatingly thus move in orbit which is recessed from the surface of back of the human body BO, and move along the rounded human body, to thereby produce a gentler rubbing therapy unlike the case of the aforementioned “loosening-up movement.” For the “rubbing movement,” the massage balls 21 need to slightly thrust up toward the human body BO.

As described above, performed as a first operation is keeping the back straight and the “rubbing movement,” thereby to provide a relatively weak stimulus over the whole back of the user and to activate the back. In the next processing, the shoulder position is estimated by estimating the height of the shoulder position from a surface of the seat 12 on which the user is seated. The estimation is possible according to the pressure, etc., to which the massage balls 21 are subject during the operation of keeping the back straight and the “rubbing movement.”

When the shoulders position is thus estimated, the control circuit 6 estimates each of or, one or two of the area of the shoulders to be massaged (hereinafter referred to as shoulders area), area of the back to be massaged (hereinafter referred to as back area), and area of the waist to be massaged (hereinafter referred to as waist area) which are determined in advance as a specified proportional relationship based on a distance between the surface of the seat and the shoulder position of the user, to perform a detection massage (preliminary massage) for each area, to thereby judge sensation of stiffness for each area (step S44, S45, S46).

The judging principle of the sensation of stiffness is already known, and therefore will not be described. The massage machine of the present embodiment judges the sensation as classified into four steps of “relaxed,” “neutral,” “activity,” and “pain” by using a detection result of a pulse sensor 52 and a GSR sensor 51 based on two relaxation indicating factors of GSR and pulse, as seen in FIG. 12. Specifically the aforementioned judging result of four steps is obtained based on slope of GSR during each detection time, e.g., between five seconds and seven seconds, and slope of pulse.

An area as judged as “activity” of the aforementioned judging result is one having sensation of stiffness, i.e., activity reaction, and is to be efficiently given an intensive therapy. On the other hand, for an area as judged as “pain,” the sensation of stiffness is severe, and the intensive therapy is likely to bring the opposite effect.

A1 is the frequency of Shiatsu determined in accordance with the judging result of the shoulders area shown in step S44 of FIG. 18. A2 is the frequency of Shiatsu determined in accordance with the judging result of the back area shown in step S45. A3 is the frequency of Shiatsu determined in accordance with the judging result of the waist area shown in step S46.

Thus obtained are the judging result of sensation of stiffness for the shoulder area, back area, and waist area, respectively, and the frequency of Shiatsu which is determined in accordance with the judging result. The massages for these steps S44, S45, S46 are effective as loosening up the entire body at the same time. Accordingly blood circulation is promoted by loosening up every muscle.

Subsequently the control circuit 6 detects sensation of stiffness for the points of Shiatsu (five points are specified for this embodiment) of the shoulders area, respectively. The judging result obtained by this detection is added to the judging result A1 in step S44 and of sensation of stiffness for the shoulders area, to obtain B1 as a judging result (step S47). When the position of the shoulders of the user is previously estimated, the massage machine estimates not only the points of Shiatsu of the shoulders area, but the positions of shoulders area, back area, waist area, respectively. Further it is possible to estimate the points of Shiatsu within each of the areas according to a relative position relationship which is determined in advance.

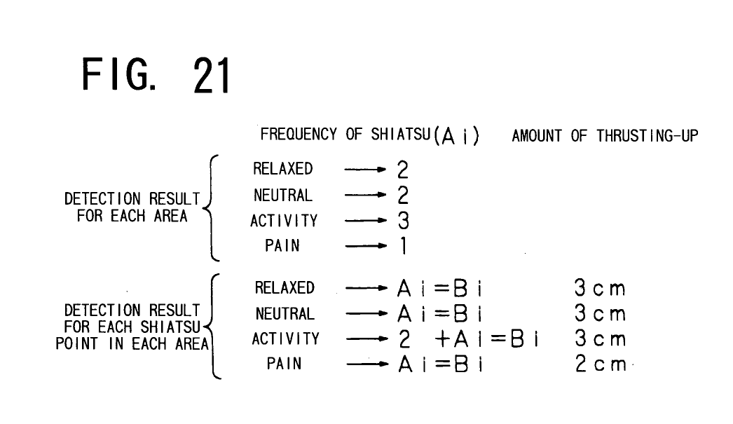

FIG. 21 shows a procedure of determining frequency B1 of Shiatsu to be obtained in step S47 wherein Ai (i=1: shoulders area, 2: back area, 3: waist area) is the frequency of Shiatsu specified in accordance with the judging result of each of the areas in steps S44 to S46. Specifically when the judging results of sensation of stiffness for the shoulders are, for example, “relaxed,” “neutral,” “activity,” “pain,” in step S44, the frequency A1 of Shiatsu is respectively “two,” “two,” “three,” “one.” Only when the judging result for a certain point of Shiatsu within the shoulders area is “activity” in step S48, the frequency B1 of Shiatsu is “two+A1.”

For example, when the judging result in step S44 is “relaxed,” the frequency A1 of Shiatsu is “two.” When the judging result in step S47 is “neutral,” the frequency B1 of Shiatsu is remained “A1,” i.e., “two.” When the judging result in step S44 is “neutral,” the frequency A1 of Shiatsu is “two.” When the judging result in step S47 is “activity,” the frequency B1 of Shiatsu is “two+A1,” i.e., “four.”

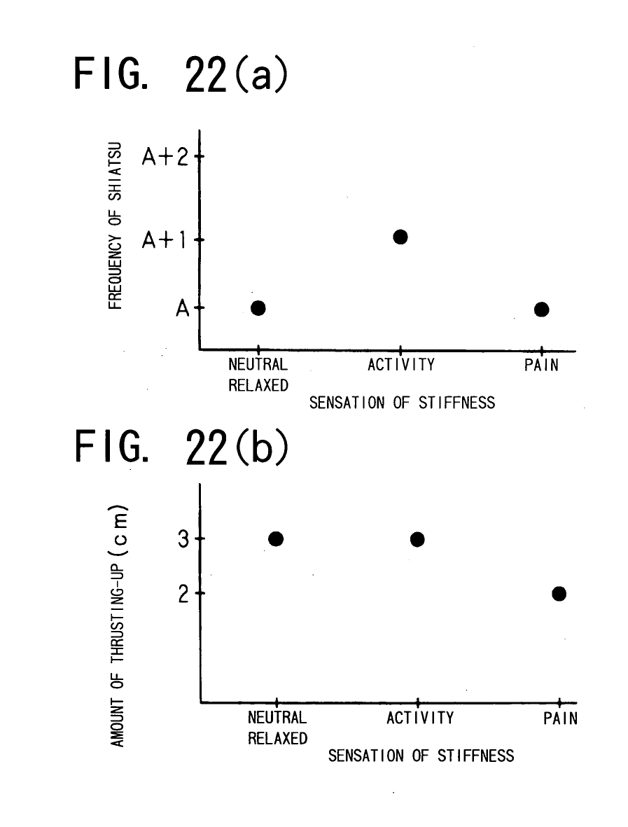

The judgment is thus made in two steps, whereby the parts having sensation of stiffness, i.e., activity reaction, are to be given more intensive therapy. The amount of thrusting-up of the massage balls 21 is determined only by the judging result of sensation of stiffness for each of the points of Shiatsu. FIGS. 22(a) and 22(b) are graphs showing the relationship between the frequency of Shiatsu and sensation of stiffness, and the relationship between the amount of thrusting-up of the massage ball 21 and sensation of stiffness.

With the massage machine of the present invention, when, based on the judging result of sensation of stiffness for each area, the judging result of sensation of stiffness for each of the points of Shiatsu within said area is the specified result, or specifically only when said judging result is “activity,” frequency of Shiatsu which is determined in advance is added, to thereby determine the frequency of Shiatsu for each of the points of Shiatsu. This will not produce extreme differences in frequency of therapy (frequency of Shiatsu) among the points of Shiatsu within each of the areas, and, moreover, makes it possible to give the intensive therapy to the points of Shiatsu judged as “activity” which is most effective for the therapy.

As mentioned above, the control circuit 6 gives a therapy to the points of Shiatsu to be massaged by the frequency of therapy (frequency of Shiatsu) determined in step S47 (step S48). When the therapy for each of the points of Shiatsu within the shoulders area is thus completed, the control circuit 6 performs a loosening-up movement for the entire shoulders area (step S49). This is because local parts such as the points of Shiatsu within the shoulders area are given the massage therapy, and an area which is equal to or greater than said parts, i.e., the entire shoulders area, is thereafter given the muscle loosening-up movement, to thereby promote blood circulation.

The back area (step S50, S51, S52) and the waist area (step S53, S54, S55) will be given the same processing as that for the aforementioned shoulders area (step S47, S48, S49).

When the therapy for each of the shoulders area, back area, and waist area is thus completed, the control circuit 6 performs a loosening-up massage over the entire body, e.g., loosening-up, the combination of tapping and kneading, etc. (step S56). This is because a local area such as the shoulders area, back area, waist area is given the massage therapy, and an area which is equal to or greater than said local area, in this case, the entire body, is thereafter given the muscle loosening-up movement, to thereby promote blood circulation.

In the last step, the control circuit 6 performs a rolling movement for keeping straight the back of the user seated on the massage machine, as in the same procedure of the aforementioned step S42, and a rubbing movement (step S57).

The area to be massaged is not limited to the three areas of the shoulders, back, and waist areas as in the embodiment as described above. Furthermore, whereas according to the embodiment described, the massage therapy is given to all of the shoulders, back, and waist areas as the area to be massaged, only one or, two of these three areas may be given the massage therapy.

As described in detail, the massage machine of the present embodiment determines the massage operation based on the judging result of sensation of stiffness in the event of the preliminary massage given to each of the areas to be massaged, and the judging result of sensation of stiffness in the event of the preliminary massage given to each of the points of Shiatsu within each of the areas to be massaged, so that the machine performs more appropriate massage operation for each of the points of Shiatsu.

When the judging result of sensation of stiffness is the specified result in the case where the preliminary massage operation is given to a certain point of Shiatsu within a certain area to be massaged, the massage machine performs a stronger massage operation than that determined based on the judging result of sensation of stiffness in the event of the preliminary massage operation given to said area to be massaged including said point of Shiatsu, so that a point of Shiatsu which needs to be given a particularly intensive massage can be given an effective massage operation.

Furthermore the preliminary massage operation is performed to the area to be massaged with gentler movement of the massage ball than that based on the detection value of the physiological sensor, sensation of stiffness for each of the areas to be massaged is judged during said preliminary massage operation, and the massage operation is performed based on the detected sensation of stiffness. This does not increase the strain on the user.

The same massage ball can consecutively perform the two massage movements: loosening-up movement wherein the massage balls which are movable in circular or elliptical orbit forward, rearward, leftward, and rightward relative to the body of the user reciprocatingly moves in orbit which is part of the circular or elliptical orbit and which protrudes against the body of the user, and rubbing movement wherein the massage ball reciprocatingly moves in orbit which is recessed from the body of the user. Accordingly the massage therapy is so performed that the massage movements are repeated with higher frequency.

With the massage machine of the present invention, the preliminary massage operation is performed for the area to be massaged and of shoulders, back and/or waist with gentler movement of the massage balls than that based on the value detected by the sensor, a position of an area to be massaged and of shoulders, back, and/or waist, and a position of a point of Shiatsu, i.e., a point which is to be given Shiatsu or finger pressure therapy, within each of the areas to be massaged are estimated, sensation of stiffness for each of the areas to be massaged is judged based on the detected value of the sensor in the event of the preliminary massage operation performed for the area to be massaged, the preliminary massage operation for each of the points of Shiatsu within the area to be massaged is performed with gentler movement of the massage balls than that based on the value detected by the sensor to judge sensation of stiffness for each of the points of Shiatsu based on the detected value of the sensor, and a massage operation for each of the points of Shiatsu is performed based on sensation of stiffness judged for the area to be massaged and sensation of stiffness judged for each of the points of Shiatsu within each of the areas to be massaged, whereby so-called low impact therapy can be achieved, such that resistance force against stimulus will not unconsciously be imposed in the body.

Furthermore, when the massage operation for each of the points of Shiatsu within each of the areas to be massaged is completed, the rubbing movement is given. When the massage operation for each of the points of Shiatsu within each of the areas to be massaged is completed, the loosening-up movement is given. This makes it possible to achieve lower-impact therapy.

The preliminary massage operation is performed as the rubbing movement wherein the massage balls reciprocatingly move in orbit which is a recessed part of circular or elliptical orbit forward, rearward, leftward, and rightward relative to the body of the user, so that the massage therapy is so performed that the massage movements are repeated with higher frequency, and are performed along the rounded human body to thereby produce gentler massage movements.

Furthermore, the preliminary massage operation is performed as the loosening-up movement wherein the massage balls reciprocatingly move in orbit which is a protruded part of circular or elliptical orbit forward, rearward, leftward, and rightward relative to the body of the user, so that the massage therapy is so performed that the massage movements are repeated with higher frequency. Moreover, muscle is pressed by the massage ball, to thereby achieve kneading and loosening-up effect on muscle.

When the judging result of sensation of stiffness is the specified result in the case where the preliminary massage operation is given to each of the points of Shiatsu within each of the areas to be massaged, the massage machine performs a stronger massage operation than that determined based on the judging result of sensation of stiffness in the event of the preliminary massage operation given to said area to be massaged including said point of Shiatsu, so that a point of Shiatsu which needs to be given a particularly intensive massage can be given an effective massage operation.

Furthermore, the massage operation is performed for a plurality of areas to be massaged, and gentler massage operation is thereafter performed for the areas including these areas, whereby so-called “low-impact” can be realized, such that resistance force against stimulus will not unconsciously be imposed in the body.

What is claimed is:

1. A massage machine comprising a physiological sensor for detecting physiological data of a person to be massaged and a control circuit for controlling a massage operation based on the physiological data detected by the physiological sensor, the control circuit comprising psychological state estimating means for estimating a psychological state of the person to be massaged based on the physiological data detected by the physiological sensor by an execution of a preliminary massage and massage operation adjusting means for adjusting a full massage operation in accordance with the estimated psychological state, the preliminary massage being performed by one typical massage movement from among a plurality of kinds of massage movements to be performed for the full massage to detect variations of the physiological data.

2. A massage machine according to claim 1 wherein one kind of massage movement is selected as the one typical massage movement so as to produce a psychological state which is closest to a state wherein all of the plurality of kinds of massage movements to be performed for the full massage are consecutively performed.

3. A massage machine comprising a physiological sensor for detecting physiological data of a person to be massaged and a control circuit for controlling a massage operation based on the physiological data detected by the physiological sensor, the control circuit comprising psychological state estimating means for estimating a psychological state of the person to be massaged based on the physiological data detected by the physiological sensor by an execution of a preliminary massage and massage operation adjusting means for adjusting a full massage operation in accordance with the estimated psychological state, the person to be massaged being given a massage therapy by alternately repeating the preliminary massage and full massage.

4. A massage machine according to claim 3 wherein the preliminary massage is performed by one typical massage movement from among a plurality of kinds of massage movements to be performed for the full massage to detect variations of the physiological data.

5. A massage machine according to claim 4 wherein one kind of massage movement is selected as the one typical massage movement so as to produce a psychological state which is closest to a state wherein all of the plurality of kinds of massage movements to be performed for the full massage are consecutively performed.

6. A massage machine according to claim 3 wherein one time preliminary massage is executed by performing massage operations on all parts to be massaged for the full massage.

7. A massage machine according to claim 3 wherein one time preliminary massage is executed by performing a massage operation on one of all parts to be massaged for the full massage, and a part to be massaged is switched every preliminary massage.

8. A massage machine according to claim 3 wherein one time full massage is executed by performing all of the plurality of kinds of massage movements to be executed for the full massage.

9. A massage machine according to claim 3 wherein one time full massage is executed by performing one kind of massage movement from all of the plurality of kinds of massage movements to be executed for the full massage, and a kind of massage movement is switched every full massage.

10. A massage machine comprising a sensor for detecting physiological data of a person to be massaged, the massage machine for performing a massage operation by moving massage balls based on a detected value of the sensor, the massage machine comprising:
means for performing a preliminary massage operation for an area to be massaged,
means for estimating a position of an area to be massaged and of shoulders, back, and/or waist, and a position of a point of Shiatsu, i.e., a point which is to be given Shiatsu or finger pressure therapy, within each area to be massaged,
means for judging sensation of stiffness for each said area to be massaged based on a value of the sensor detected when the preliminary massage operation is performed for each said area to be massaged,
means for judging sensation of stiffness for each point of Shiatsu based on a value of the sensor detected when the preliminary massage operation is performed for each point of Shiatsu within each said area to be massaged, and
means for performing a massage operation for each point of Shiatsu based on the sensation of stiffness judged for each said area to be massaged, and the sensation of stiffness judged for each point of Shiatsu within each said area to be massaged.

11. A massage machine according to claim 10 wherein when the judging result of sensation of stiffness is a specified result in the case where the preliminary massage operation is given to each point of Shiatsu within each said area to be massaged, a stronger massage operation is performed than a massage operation determined based on the judging result of sensation of stiffness in the event of the preliminary massage operation given to each said area to be massaged.

12. A massage machine comprising a sensor for detecting physiological data of a person to be massaged, the massage machine for performing a massage operation by moving massage balls based on a detected value of the sensor, the massage machine comprising:
means for performing a preliminary massage operation for areas to be massaged with a gentler movement of the massage balls than said movement of the massage balls based on the value detected by the sensor,
means for judging sensation of stiffness for each said area to be massaged based on a value of the sensor detected when the preliminary massage operation is performed for each said area to be massaged, and
means for performing the massage operation based on the detected sensation of stiffness.

13. A massage machine for performing a massage operation by moving massage balls which are movable in circular or elliptical orbit forward, rearward, leftward, and rightward relative to a body of a person to be massaged, the massage machine performing a massage operation so as to reciprocatingly move the massage balls in orbit which is a part of the circular or elliptical orbit and which protrudes against the body of the person to be massaged.

14. A massage machine for performing a massage operation by moving massage balls which are movable in circular or elliptical orbit forward, rearward, leftward, and rightward relative to a body of a person to be massaged, the massage machine performing a massage operation so as to reciprocatingly move the massage balls in orbit which is a part of the circular or elliptical orbit and which is recessed from the body of the person to be massaged.

15. A massage machine for performing a massage operation by moving massage balls which are movable in circular or elliptical orbit forward, rearward, leftward, and rightward relative to a body of a person to be massaged, the massage machine selectively performing:
a massage operation for reciprocatingly moving the massage balls in orbit which is a part of the circular or elliptical orbit and which protrudes against the body of the person to be massaged, and
a massage operation for reciprocatingly moving the massage balls in orbit which is a part of the circular or elliptical orbit and which is recessed from the body of the person to be massaged.

16. A massage method for a massage machine to perform a massage operation, the massage machine for moving massage balls based on a value detected by a sensor for detecting physiological data of a person to be massaged, the massage method having:
a step of performing a preliminary massage operation for an area to be massaged and of shoulders, back and/or waist, with a gentler movement of the massage balls than said movement of the massage balls based on the value detected by the sensor,
a step of estimating a position of an area to be massaged and of shoulders, back, and/or waist, and a position of a point of Shiatsu, i.e., a point which is to be given Shiatsu or finger pressure therapy, within each area to be massaged,
a step of judging sensation of stiffness for each said area to be massaged based on a value of the sensor detected when the preliminary massage operation is performed for each said area to be massaged,
a step of performing the preliminary massage operation for each point of Shiatsu within each said area to be massaged with a gentler movement of the massage balls than said movement of the massage balls based on the value detected by the sensor, and judging sensation of stiffness for each point of Shiatsu based on a detected value of the sensor, and
a step of performing a massage operation for each point of Shiatsu based on the sensation of stiffness judged for each said area to be massaged, and the sensation of stiffness judged for each point of Shiatsu within each said area to be massaged.

17. A massage method for a massage machine to perform a massage operation, the massage machine for moving massage balls based on a value detected by a sensor for detecting physiological data of a person to be massaged, the massage method having:
a step of performing a preliminary massage operation for an area to be massaged and of shoulders, back and/or waist, with a gentler movement of the massage balls than said movement of the massage balls based on the value detected by the sensor,
a step of estimating a position of an area to be massaged and of shoulders, back, and/or waist, and a position of a point of Shiatsu, i.e., a point which is to be given Shiatsu or finger pressure therapy, within each area to be massaged,
a step of judging sensation of stiffness for each said area to be massaged based on a value of the sensor detected when the preliminary massage operation is performed for each said area to be massaged,
a step of performing the preliminary massage operation for each point of Shiatsu within each said area to be massaged with a gentler movement of the massage balls than said movement of the massage balls based on the value detected by the sensor, and judging sensation of stiffness for each point of Shiatsu based on a detected value of the sensor,
a step of performing a massage operation for each point of Shiatsu based on the sensation of stiffness judged for each said area to be massaged and the sensation of stiffness judged for each point of Shiatsu within each said area to be massaged,
a step of performing a loosening-up movement for each said area to be massaged in its entirety after completion of the massage operation for each point of Shiatsu within each of the areas to be massaged, and
a step of performing a loosening-up movement for an area including each of the areas to be massaged after completion of the massage operation for each point of Shiatsu within each said area to be massaged.

18. A massage method according to claim 17 wherein the preliminary massage operation is performed as a rubbing movement for reciprocatingly moving the massage balls forward, rearward, leftward, and rightward in orbit which is a part of circular or elliptical orbit and which is recessed from a body of the person to be massaged.

19. A massage method according to claim 17 wherein the preliminary massage operation is performed as a loosening-up movement for reciprocatingly moving the massage balls forward, rearward, leftward, and rightward in orbit which is a part of circular or elliptical orbit and which protrudes against a body of the person to be massaged.

20. A massage method according to claim 17 wherein when the judging result of sensation of stiffness is a specified result in the case where the preliminary massage operation is given to each point of Shiatsu within each said area to be massaged, a stronger massage operation is performed than a massage operation determined based on the judging result of sensation of stiffness in the event of the preliminary massage operation given to said each area to be massaged.

21. A massage method for a massage machine to perform a massage operation, the massage method having
a step of performing a massage operation for a plurality of areas to be massaged, and
a step of performing a massage operation for the plurality of areas, and thereafter performing a gentler massage operation for an area including the plurality of areas than said massage operation.
